(19) United States
(12) Patent Application Publication
(10) Pub. No.: US 2024/0041241 A1
(43) Pub. Date: Feb. 8, 2024

(54) Beverage Brewing System

(71) Applicant: Adrian Rivera, Whittier, CA (US)

(72) Inventor: Adrian Rivera, Whittier, CA (US)

(21) Appl. No.: 18/231,220

(22) Filed: Aug. 7, 2023

Related U.S. Application Data
(60) Provisional application No. 63/395,588, filed on Aug. 5, 2022.

(51) Int. Cl. A47J 31/06; A47J 31/20

(52) U.S. Cl. CPC A47J 31/0626; A47J 31/20

(57) ABSTRACT

A brewing material holder for a beverage brewer includes a filter housing, and an internal filter. The filter housing includes a housing sidewall defining a housing interior volume, and an open end configured to receive brewing material into the housing interior volume. The internal filter includes a filter sidewall having at least one filter opening, and at least one filter mesh element covering the at least one filter opening. The internal filter is configured to engage the filter housing such that the internal filter is arranged within the housing interior volume.

### CROSS-REFERENCE TO RELATED APPLICATION

This is related to, and claims priority from, U.S. Provisional Application for Patent No. 63/395,588, which was filed on Aug. 5, 2022, the entire disclosure of which is incorporated herein by this reference.

### FIELD OF THE INVENTION

The present invention relates to beverage brewing and in particular to a brewing device for hot or cold brewing of beverages.

### BACKGROUND OF THE INVENTION

Several types of beverages, such as coffee, tea, and herbal drinks, are brewed by infusing or steeping ground or shredded beverage material in water or other liquid. For quick brewing, hot water is typically used. However, cold brewing, that is, infusion of the beverage material in cold or room-temperature water rather than in hot water, is sometimes preferred. For example, some coffee drinkers prefer the flavor provided by cold brewing, and bitterness and acidity can be avoided when brewing certain teas by steeping in unheated water rather than hot water. Such cold brewing is accomplished by submerging a portion of brewing material in unheated water for a period of time to allow the brewing material to infuse the water. While the steeping process may provide a desired result, the time required for cold brewing is longer than that required for brewing in hot water.

Conventional cold-brew steeps require a user to measure and pour a particular amount of brewing material into the steep liquid. A pre-measured simple drop-in portion of brewing material would be convenient, particularly for use in a brewer that simplifies removal of the brewing material and clean-up of the brewer. A brewer that can be used for both hot- and cold-brewing would provide flexibility, and it would be advantageous if the brewer would be configured to speed the cold-brewing process.

It would also be advantageous to provide a feature by which the brewing time is reduced when the beverage is cold-brewed. Many people prefer the taste of a cold-brewed beverage, but cold-brewing typically takes a much longer time than does traditional hot-brewing. Adding an agitation or rotation action to the cold-brewing process has been shown to reduce the cold-brewing time. Another manner of speeding the process would be to increase a rate of flow of brewing liquid through the brewing material. Some conventional devices use a gravity feed to draw water through the brewing material using a percolator-type action, which speeds brewing time somewhat. However, these systems tend to have a motorized system outside the brewing container to provide the gravity action, resulting in a brewer having a large footprint that takes up considerable counter space. Also, the complexity of these systems makes them difficult to clean property and exposes users to potential build-up of bacteria and other contaminants that affect the taste of the beverage and the health of the user.

However, a reliable, cold-brewing system that increases fluid flow or contact would provide quicker brewing and an overall improved brewing experience. Flexibility would be provided if the brewing system can also be used to hot-brew a beverage.

### BRIEF SUMMARY OF THE INVENTION

The invention addresses the above and other needs by providing a hot/cold beverage brewing device that reduces the time required to cold-brew coffee and other beverages by increasing the surface area of brewing material that is in contact with the steeping water during the brewing process. The brewer includes a container, and a brewing material holder configured to be suspended from a lid of the container, or from the top of the container, into the container. The brewing material holder is made from a mesh material, lined in a mesh material, or includes one or more mesh panels to retain brewing material in the brewing material holder. For example, the mesh can be a fine nylon mesh or a 75-micron opening nylon mesh or a metal mesh.

When brewing material, such as ground coffee beans, is placed in the brewing material holder, and the holder is suspended in a container of water or other liquid of any temperature, the brewing material comes into contact with the water through the mesh material, and over time the brewed beverage is steeped. One factor that determines the rate of brewing is the amount of contact the water has with the brewing material, which in turn can depend at least in part on the amount of mesh surface area of the brewing material holder. According to the invention, this surface area is increased by providing an additional filter element internal to the brewing material holder. This internal filter element opens into the container and provides more mesh surface area between the water in the container and the brewing material in the holder.

For example, a tube can be configured to be arranged within the brewing material holder, with a longitudinal axis preferably aligned with the longitudinal axis of the brewing material holder. The tube has an open end at a closed bottom of the brewing material holder, such that it opens into the container when the brewing material holder is suspended within the container, and a closed or mesh-covered opposite end. The tube is also made from a mesh material, lined in a mesh material, or includes one or more mesh panels, so that water from the container can enter the tube through the open bottom and can pass through the mesh elements into the brewing material holder. In this way, brewing material in the brewing material holder can come in contact with water through the mesh elements in the tube as well as the mesh elements in the brewing material holder, increasing the surface area of brewing material in contact with the water, thereby increasing the speed at which the beverage brews.

To brew a beverage, water or other liquid is added into the container and brewing material is disposed in the brewing material holder, which is submerged in the liquid in the container. Water in the container comes into contact with the brewing material through the mesh portions of the brewing material holder, as well as through the mesh portions of the tube. The brewing material added to the holder can be loose material or can be a prepackaged capsule, pod, or other container of brewing material. The tube can be elongated to provide a large surface area, and can be straight, twisty, curled, serpentine, or assume any shape practical for arrangement within the brewing material holder.

The tube can couple with or attach to the brewing material holder, preferably at a bottom end of the brewing material holder, directly, or by screwing into a coupler such as a cap-end of the brewing material holder, or by being integrated into a cap-end of the brewing material holder. Alternatively, the tube can snap-fit, friction-ft, or otherwise be attached to or couple with the brewing material holder, preferably at a lower end of the brewing material holder, directly or through an intermediate element. Regardless of how the tube is engaged and where it is engaged, the open end of the tube is arranged to allow water from the container into the tube, which is arranged within the brewing material holder for beneficial contact with brew material within the holder. Mesh portions of the tube can be strategically arranged to provide maximum contact and even flow, for example, if a user shakes or otherwise agitates the container during steeping/brewing.

According to an aspect of the invention, a brewing material holder for a beverage brewer includes a filter housing and an internal filter. The filter housing includes a housing sidewall defining a housing interior volume, and an open end configured to receive brewing material into the housing interior volume. The internal filter includes a filter sidewall having at least one filter opening, and at least one filter mesh element covering the at least one filter opening. The internal filter is configured to engage the filter housing such that the internal filter is arranged within the housing interior volume.

The internal filter can have an open end, and the filter sidewall can define a filter interior volume. The brewing material holder can also include a filter coupler configured to couple the internal filter with the filter housing, in which case the open end of the internal filter can be configured to couple with the filter coupler at an opening in the filter coupler.

The housing sidewall can have at least one housing opening, and the filter housing ca include at least one housing mesh element covering the at least one housing opening.

The filter housing can be configured to be suspended in a container that is configured to hold liquid.

According to another aspect of the invention, a beverage brewer can include the brewing material holder, and the container.

According to another aspect of the invention, a brewing material holder for a beverage brewer includes a filter housing configured to receive and hold beverage brewing material, and an internal filter. The filter housing includes a housing body having at least one housing opening, and at least one housing filter element covering the at least one housing opening. The internal filter includes an internal filter body having at least one internal opening, and at least one internal filter element covering the at least one internal opening. The filter housing and the internal filter are configured for mutual engagement such that the internal filter is arranged inside the filter housing. The filter housing can include a first open end, a second open end, and a sidewall. The filter housing can be configured to receive beverage brewing material through the first open end. The at least one housing opening can be arranged at least in the filter housing sidewall. The internal filter body can include a first end, a second end, and a sidewall. The internal filter body first end is open, and the internal filter body second end is at least partially closed. The at least one internal opening can be arranged at least in the internal filter body sidewall. The filter housing and the internal filter can be configured for mutual engagement such that the first end of the internal filter body is arranged at the second open end of the filter housing.

The brewing material holder can also include a filter cap configured to be removably coupled to the second open end of the filter housing. The filter cap can have a central opening that is configured to engage with the open end of the internal filter body such that the open end of the internal filter body opens through the central opening. The filter cap can include at least one cap opening, and at least one cap filter element covering the at least one cap opening.

The second end of the internal filter body can be closed, and can be rounded.

The brewing material holder can also include a filter housing cap configured to engage and cover the first open end of the filter housing. The filter housing cap can include at least one filter housing cap opening, and at least one housing cap filter element covering the at least one filter housing cap opening. The filter housing cap can include a recessed portion configured to engage the second end of the internal filter body when the internal filter body is arranged inside the filter housing.

The internal filter body can have an elongated shape.

According to another aspect of the invention, a beverage brewer includes a container assembly, a lid assembly, and the brewing material holder. The container assembly, the lid assembly, and the brewing material holder are configured to mutually engage such that the brewing material holder is suspended inside the container assembly.

The lid assembly can be configured to cover an open end of the container assembly. The lid assembly can include a lid collar, and a flip lid. The lid collar can be configured to engage the open end of the container assembly such that the open end of the container assembly opens through an opening in the lid collar. The flip lid can be hingedly coupled to the lid collar to selectively cover the opening in the lid collar.

### BRIEF DESCRIPTION OF THE DRAWINGS

These and other aspects, features, and advantages of the present invention will be more apparent from the following more detailed description thereof, with reference to the following drawings wherein:

FIG. 1A shows an exemplary beverage brewing device of the present invention.

FIG. 1B shows an exemplary container assembly of the present invention.

FIG. 1C shows an exemplary container of the present invention.

FIG. 2 shows an exemplary brewing material holder of the present invention.

FIG. 3 shows an exemplary filter housing of the present invention.

FIG. 4A shows an exemplary internal filter of the present invention.

FIG. 4B shows an exemplary internal filter of the present invention.

FIG. 5A shows an exemplary internal filter arranged within a filter housing of the present invention.

FIG. 5B shows an exemplary internal filter arranged within a filter housing of the present invention.

FIG. 6A shows an exemplary filter cap of the present invention.

FIG. 6B shows an exemplary filter cap of the present invention.

FIG. 7A shows an exemplary filter cap engaged with a first end of an internal filter of the present invention.

FIG. 7B shows an exemplary filter cap engaged with a first end of an internal filter of the present invention.

FIG. 8A shows an exemplary filter housing cap of the present invention.

FIG. 8B shows an exemplary filter housing cap of the present invention.

FIG. 8C shows an exemplary filter housing cap of the present invention.

FIG. 9 shows an exemplary filter housing cap covering a first open end of a filter housing of the present invention.

FIG. 10A shows an exemplary lid assembly of the present invention.

FIG. 10B shows an exemplary lid assembly of the present invention.

FIG. 10C shows an exemplary lid assembly of the present invention.

FIG. 11 shows an exemplary lid assembly coupled to a brewing material holder of the present invention.

FIG. 12 shows an exemplary hinge pin of the present invention.

FIG. 13 shows an exemplary brewing material holder coupled to a lid assembly of the present invention.

FIG. 14 shows an exemplary container collar engaged with a lid assembly of the present invention.

FIG. 15 shows an exemplary internal filter with a second end secured by a recessed spot of a filter housing cap of the present invention.

Corresponding reference characters indicate corresponding components throughout the several views of the drawings.

### DETAILED DESCRIPTION OF THE INVENTION

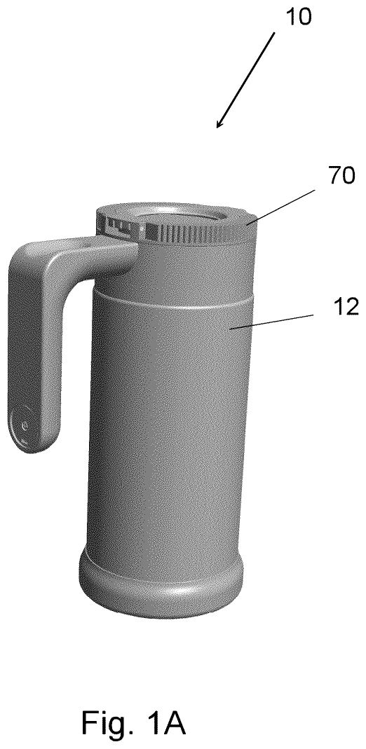

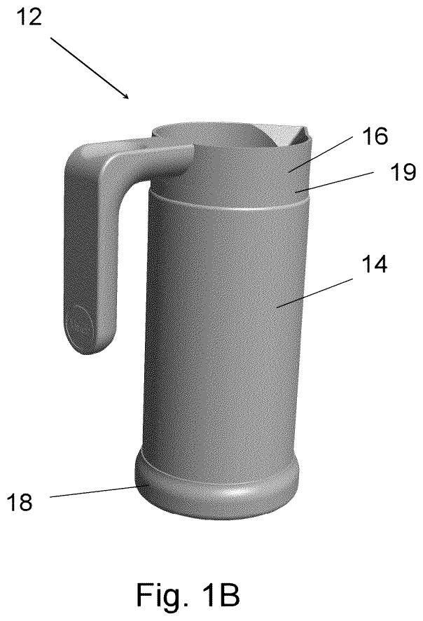

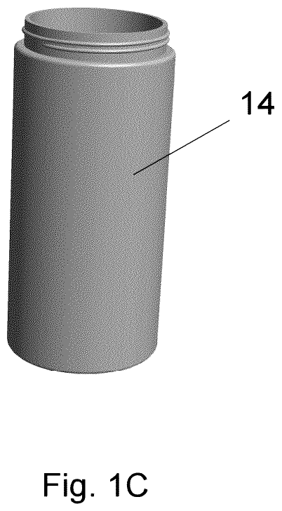

An exemplary beverage brewing device 10, container assembly 12, and container 14 according to the present invention are shown in FIGS. 1A, 1B, and 1C, respectively. The beverage brewing device 10 includes a container assembly 12 that includes a container 14 for receiving and holding water for brewing. The container 14 can be made of any suitable material, such as plastic or glass, and can be transparent to allow viewing the beverage as it brews, although opaque or translucent materials can be used to form the container 14 as well. As shown, the container 14 preferably includes closed sides or a closed sidewall, a closed bottom, and an open mouth, and can take any suitable shape, such as the generally cylindrical shape shown.

The container assembly 12 can also include a container collar 16 and a base 18. The container collar 16 is configured to couple with or otherwise be arranged on the container 14 and can include, for example, a handle and a pour spout to facilitate dispensing a beverage from the container 14. The container assembly 12 can optionally include a decorative band 19 for aesthetic or branding purposes, and preferably includes a collar seal arranged between the container collar 16 and the container 14. The base 18 can be arranged at the bottom end of the container 14 to provide stability for the brewing device 10.

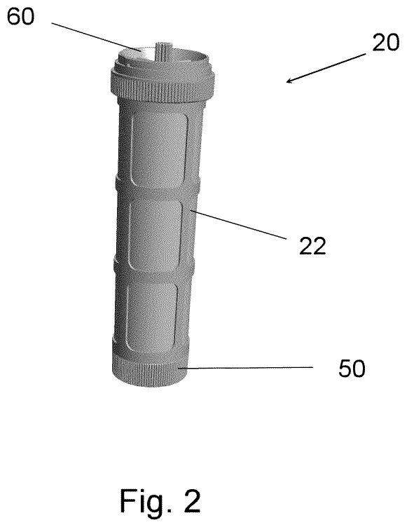

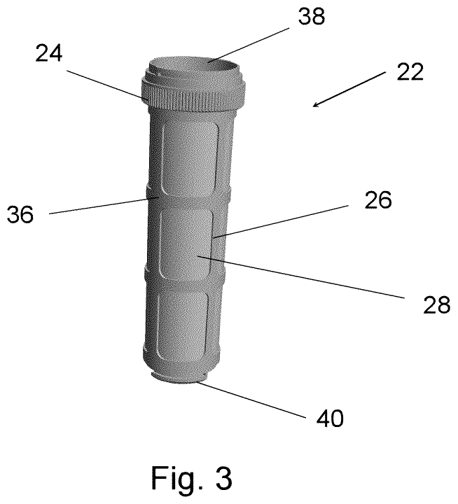

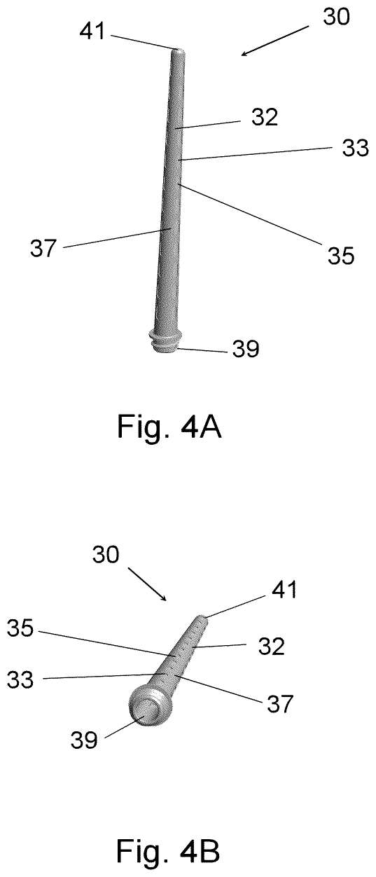

FIG. 2 shows an exemplary brewing material holder 20 according to the invention. The brewing material holder 20 includes a filter housing 22 (FIG. 3) and an internal filter 30 (FIGS. 4A and 4B). The filter housing 22 includes a filter housing body 24 having a sidewall 36, a first end 38, and a second end 40. The first end 38 is open to receive beverage brewing material such as ground coffee beans, and the sidewall 36 has one or more openings 26 and filter elements 28 such as mesh panels covering the openings 26. The filter-covered openings 26 allow water from the container 14 to pass through to the interior of the brewing material holder 20, to mix with the beverage brewing material and brew a beverage.

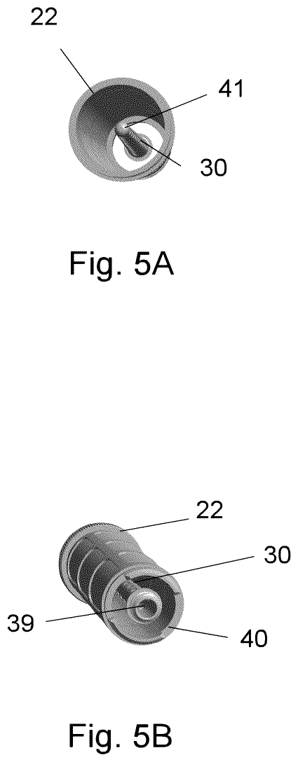

The internal filter 30 includes an internal filter body 32 having a sidewall 37, a first end 39, and a second end 41. The sidewall 37 has one or more openings 33 and filter elements 35 such as mesh panels covering the openings 33. The internal filter 30 is configured to be arranged within the filter housing 22, as shown in FIGS. 5A and 5B. The second end 41 is closed, or alternatively, covered in filter material such as mesh. The first end 39 is open to receive water from the container 14. The filter-covered openings 33 allow water from the container 14 to pass through to the interior of the brewing material holder 20, to mix with the beverage brewing material and brew a beverage. These openings 33, provided in addition to the filter housing 22 openings 26 allow for extra flow-through of water to the beverage brewing material for brewing a beverage. The internal filter 30 is preferably elongated, that is, is longer than it is wide, and is preferably at least half as long as the filter housing 22. The internal filter is preferably sized and shaped to provide a large surface area, and can be straight, twisty, curled, serpentine, or assume any shape practical for arrangement within the filter housing 22.

The filter housing 22 and the internal filter 30 can be integrally formed, joined at the inner periphery of the second end 40 of the filter housing 22 and the outer periphery of the first end 39 of the internal filter 30. The surface over which the filter housing 22 and the internal filter 30 are joined can be a closed line or surface, or can have openings covered in filter elements such as mesh material. Alternatively, the filter housing 22 and the internal filter 30 can be separate elements, engaged at the inner periphery of the second end 40 of the filter housing 22 and the outer periphery of the first end 39 of the internal filter 30 in either a fixed manner or a detachable coupling, such as by a threaded coupling, a friction-fit coupling, or a snap-on coupling.

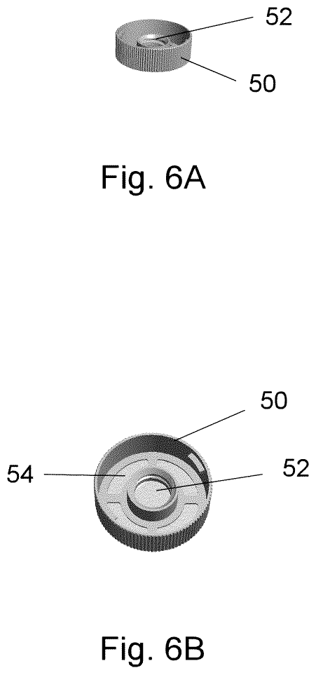

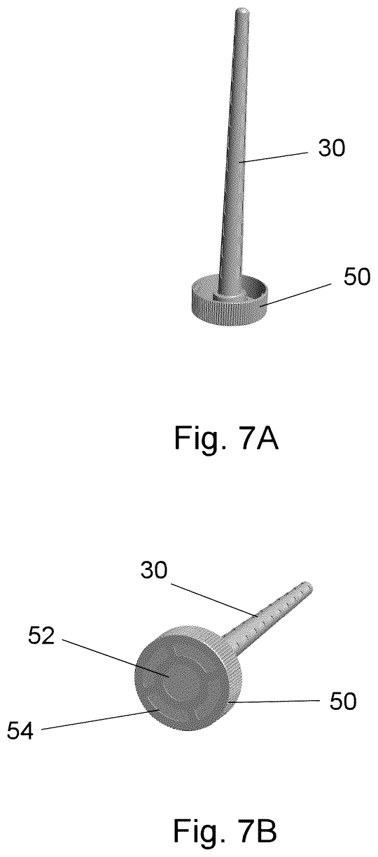

Alternatively, the brewing material holder 20 can include a coupling element configured to fixedly or detachably couple the filter housing 22 and the internal filter 30. For example, the brewing material holder 20 can include a filter cap 50 configured to be removably coupled to the second open end of the filter housing 22. FIGS. 6A and 6B show an exemplary filter cap 50 that can engage with the filter housing 22 and the internal filter 30 to detachably couple the filter housing 22 and the internal filter 30. As shown in FIGS. 7A and 7B, the filter cap 50 can engage the first end 39 of the internal filter 30, such as by a screw-on coupling or other coupling means. The filter cap 50 can also engage the second end 40 of the filter housing 22, also such as by a screw-on coupling or other coupling means, to couple the filter housing to the internal filter 30 such that the internal filter 30 is arranged inside the filter housing 22.

The filter cap 50 has a central opening 52, so that when the filter cap 50 is coupled to the open first end 39 of the internal filter 30, the open first end 39 of the internal filter 30 opens through the opening 52. When the brewing material holder 20 is suspended in the container 14, and into the container, the open first end 39 of the internal filter 30 opens through the opening 52 and into the container, so that water can pass through. The opening 52 can be completely open, or it can be covered by a filter element such as a mesh material, in order to provide an additional level of filtering. The body of the filter cap 50 can also have secondary openings 54, which are covered by filter elements such as mesh panels, providing more water flow capability from the container 14 into the filter housing 22.

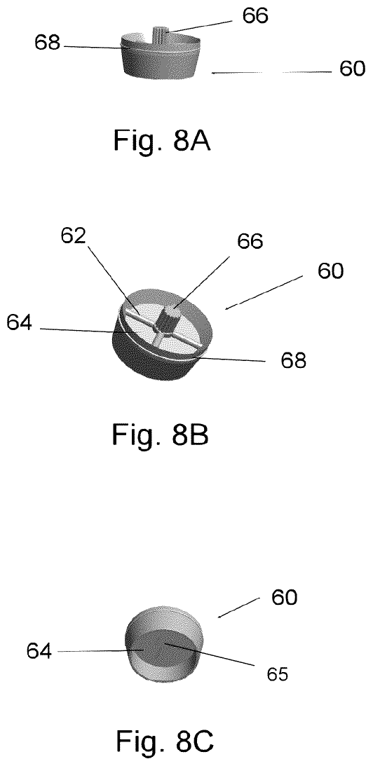

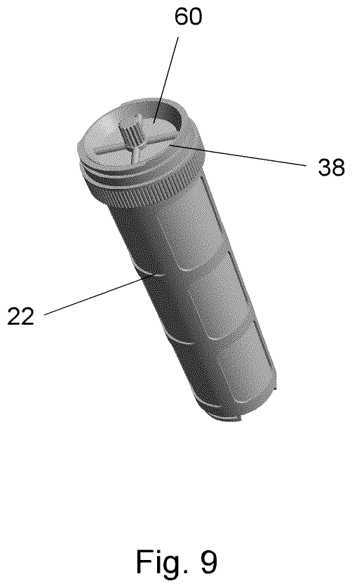

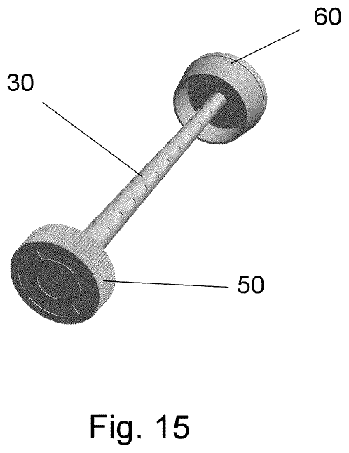

FIGS. 8A-C show an exemplary filter housing cap 60 configured to engage and cover the first open end 38 of the filter housing 22, as shown in FIG. 9. The filter housing cap 60 can include one or more openings 62, preferably covered in a filter element 64 such as a mesh material. The filter cap 60 is removably coupled to the filter housing 22, so that brewing material can be added to the interior of the filter housing 22 can prior to brewing, and so that the brewing material can be secured during brewing. The filter housing cap 60 can be removably coupled to the filter housing 22 by any of a number of ways, such as by mating screw-on or twist-on elements, by a press-fit or friction-fit arrangement, or by mating snap-on elements. The filter housing cap 60 can include a grasping element such as a knob or peg 66 for ease of use in coupling and decoupling the filter housing cap 60. A seal, such as a silicone ring 68, can be provided to provide a fluid-tight connection when the filter housing cap 60 is coupled. The underside of the filter housing cap can include an indentation or recessed spot 65, which can receive the second end 41 of the internal filter 30, holding it in place during brewing. FIG. 15 shows the internal filter 30 in place with the second end 41 secured by the recessed spot 65 of the filter housing cap 60.

A beverage would be brewed in the beverage brewing device 10 by placing beverage brewing material in the brewing material holder 20, filling the container 14 with water, and submersing the beverage brewing material in the water by suspending the brewing material holder 20 in the container 14. The beverage brewing device 10 can include a lid assembly 70 that is configured to engage the container assembly 12 and the brewing material holder 20 so that the brewing material holder 20 can be suspended in the container 14. The lid assembly 70 covers the container assembly 12 while providing access to the brewing material holder 20 to add brewing material, allows access to the container 14 to add water to the container directly or allows water to be poured into the container 14 through the brewing material holder 20 if desired. The lid assembly also provides a platform from which to suspend the brewing material holder 20 during the brewing process.

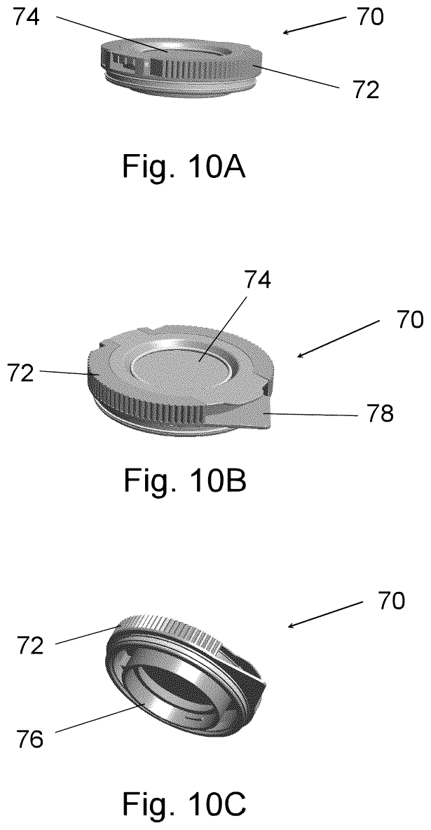

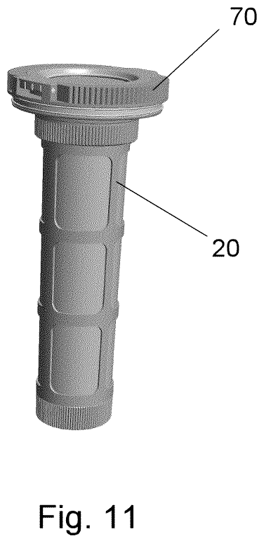

An exemplary lid assembly 70 is shown in FIGS. 10A-C. As shown, the lid assembly 70 includes a lid collar 72 and a flip lid 74 that is hingedly coupled to the lid collar 72. The lid collar 72 includes a coupler 76 that mates with the brewing material holder 20 to removably couple the lid collar 72 to the brewing material holder 20. The lid collar 72 couples with the brewing material holder 20 in any known manner, such as by screw-on connector, friction-fit mating, or snap-fit arrangement. Preferably, the lid collar 72 couples to the filter housing 22 such that the filter housing 22 open first end 38 opens through a central opening in the lid collar 72. Also, the lid collar 72 preferably couples to the filter housing 22 such that the filter housing cap 60 can be decoupled and removed from the filter housing 22 through the lid collar 72 while the filter housing 22 is coupled to the lid collar 72. The lid collar 72 also preferably includes a spout cover 78 that covers the pouring spout of the container collar 16 when in place. FIG. 11 shows the exemplary lid assembly 70 coupled to the brewing material holder 20 at the first end 38 of the filter housing 22.

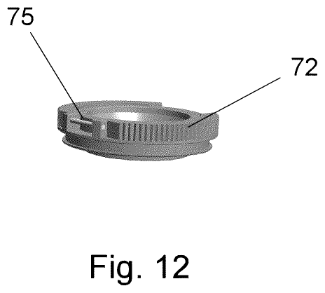

The flip lid 74 preferably is hingedly coupled to the lid collar 72, to provide access to the interior of the brewing material holder 20 while the lid collar is in place on the container assembly 12. As shown in FIG. 12, a simple hinge pin 75 can be provided to hingedly couple the flip lid 74. Any other arrangement to couple the flip lid 74 to the lid collar 72 can be provided instead, such as a screw-on connector, friction-fit mating, or a snap-fit arrangement, and the flip lid 74 can be tethered to the lid collar 72 in any known manner if desired.

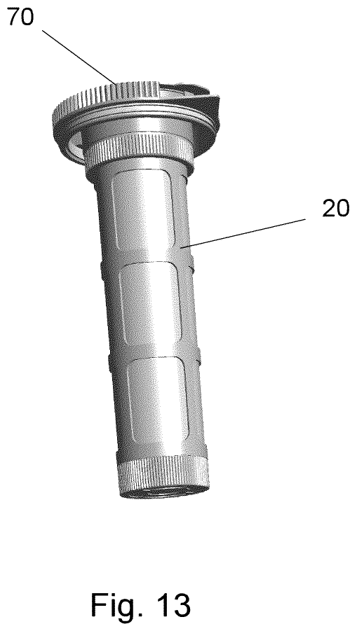

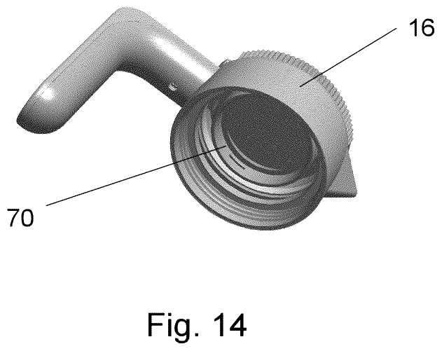

FIG. 13 shows the brewing material holder 20 coupled to the lid assembly 70, as it would when brewing a beverage. FIG. 14 shows the container collar 16 engaged with the lid assembly 70, as it would when brewing a beverage. The container collar 16 can be coupled to the lid assembly 70 in a secure manner, or the lid assembly can merely rest on a lip of the container collar 16. Thus, when the container collar 16 is in place on the container 14 and the lid assembly 70 is coupled to the brewing material holder 20 and in place on the container collar 16, the brewing material holder 20 is suspended in to the container 14 such that a beverage can be brewed, stored, and dispensed in and from a single compact apparatus using a single container.

The present invention has been described by way of example and in terms of preferred embodiments. However, the present invention as contemplated by the inventor is not strictly limited to the particularly disclosed embodiments. To the contrary, various modifications, as well as similar arrangements, are included within the spirit and scope of the present invention. The scope of the appended claims, therefore, should be accorded the broadest reasonable interpretation so as to encompass all such modifications and similar arrangements.

I claim:

1. A brewing material holder for a beverage brewer, comprising:
a filter housing; and
an internal filter;
wherein the filter housing includes a housing sidewall defining a housing interior volume, and an open end configured to receive brewing material into the housing interior volume;
wherein the internal filter includes a filter sidewall having at least one filter opening, and at least one filter mesh element covering the at least one filter opening; and
wherein the internal filter is configured to engage the filter housing such that the internal filter is arranged within the housing interior volume.

2. The brewing material holder of claim 1, wherein the internal filter has an open end, and the filter sidewall defines a filter interior volume.

3. The brewing material holder of claim 2, further comprising a filter coupler configured to couple the internal filter with the filter housing, wherein the open end of the internal filter is configured to couple with the filter coupler at an opening in the filter coupler.

4. The brewing material holder of claim 1, wherein:
the housing sidewall has at least one housing opening; and
the filter housing includes at least one housing mesh element covering the at least one housing opening.

5. The brewing material holder of claim 1, wherein the filter housing is configured to be suspended in a container that is configured to hold liquid.

6. A beverage brewer, comprising:
the brewing material holder of claim 5; and
the container.

7. A brewing material holder for a beverage brewer, comprising:
a filter housing configured to receive and hold beverage brewing material; and
an internal filter;
wherein the filter housing includes:
a housing body having at least one housing opening, and
at least one housing filter element covering the at least one housing opening;
wherein the internal filter includes:
an internal filter body having at least one internal opening, and
at least one internal filter element covering the at least one internal opening; and
wherein the filter housing and the internal filter are configured for mutual engagement such that the internal filter is arranged inside the filter housing.

8. The brewing material holder of claim 7, wherein:
the filter housing includes a first open end, a second open end, and a sidewall;
the filter housing is configured to receive beverage brewing material through the first open end;
the at least one housing opening is arranged at least in the filter housing sidewall;
the internal filter body includes a first end, a second end, and a sidewall;
the internal filter body first end is open, and the internal filter body second end is at least partially closed;
the at least one internal opening is arranged at least in the internal filter body sidewall; and
the filter housing and the internal filter are configured for mutual engagement such that the first end of the internal filter body is arranged at the second open end of the filter housing.

9. The brewing material holder of claim 8, further comprising a filter cap configured to be removably coupled to the second open end of the filter housing.

10. The brewing material holder of claim 9, wherein the filter cap has a central opening that is configured to engage with the open end of the internal filter body such that the open end of the internal filter body opens through the central opening.

11. The brewing material holder of claim 9, wherein the filter cap includes at least one cap opening, and at least one cap filter element covering the at least one cap opening.

12. The brewing material holder of claim 8, wherein the second end of the internal filter body is closed.

13. The brewing material holder of claim 12, wherein the second end of the internal filter body is rounded.

14. The brewing material holder of claim 8, further comprising a filter housing cap configured to engage and cover the first open end of the filter housing.

15. The brewing material holder of claim 14, wherein the filter housing cap includes at least one filter housing cap opening, and at least one housing cap filter element covering the at least one filter housing cap opening.

16. The brewing material holder of claim 14, wherein the filter housing cap includes a recessed portion configured to engage the second end of the internal filter body when the internal filter body is arranged inside the filter housing.

17. The brewing material holder of claim 7, wherein the internal filter body has an elongated shape.

18. A beverage brewer, comprising:
a container assembly;
a lid assembly; and
the brewing material holder of claim 7;
wherein the container assembly, the lid assembly and the brewing material holder are configured to mutually engage such that the brewing material holder is suspended inside the container assembly.

19. The beverage brewer of claim 18, further wherein the lid assembly is configured to cover an open end of the container assembly.

20. The beverage brewer of claim 19, wherein:
the lid assembly includes a lid collar, and a flip lid;
the lid collar is configured to engage the open end of the container assembly such that the open end of the container assembly opens through an opening in the lid collar; and
the flip lid is hingedly coupled to the lid collar to selectively cover the opening in the lid collar.
